(19) United States
(12) Patent Application Publication
(10) Pub. No.: US 2010/0033973 A1
(43) Pub. Date: Feb. 11, 2010

(54) LIGHT SOURCE SYSTEM

(75) Inventors: HOU-CHEN LU, Tu-Cheng (TW); KAI HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/339,059

(22) Filed: Dec. 19, 2008

(30) Foreign Application Priority Data
Aug. 8, 2008 (CN) 200810303592.9

(51) Int. Cl. F21V 29/00; F21V 7/00

(52) U.S. Cl. 362/294; 362/296.01

(57) ABSTRACT

A light source system includes a light source, a reflective device and a protecting device. The light source received in the reflective device. The reflective device including a light outlet and a through hole defined thereon is configured for reflecting light emitted from the light source to the light outlet. The protecting device is mounted on the outside of the reflective device with a space left between the protecting device and the outer surface of the reflective device. The protecting device includes a first portion substantially aligned with the through hole of the reflective device and a second portion. The first portion is configured for preventing light from leaking and objects from escaping out from light system. The second portion defines at least one ventilation hole thereon.

### BACKGROUND

1. Technical Field

The present invention relates to light source systems and, particularly, to a light source system used in a projector.

2. Description of the Related Art

A projector generally includes an illuminating optical system having a light source system, an electro-optic modulator and a projecting optical system. The light source system is configured for emitting illumination light. The electro-optic modulator is configured for modulating the illumination light from the light source system according to image signals. The projecting optical system is configured for projecting and displaying the modulated light as a display image on a screen.

In order to obtain a higher luminous intensity, a light source having a high-pressure mercury lamp combined with a reflective device (reflector) is almost always employed in the light source systems. In order to obtain better color balance, a light source having a metal halide lamp is usually employed in other light source systems.

In the light source of these kinds of light source systems, a luminous tube (vitreous silica tube) of the lamp may burst due to the increase of vapor pressure during lighting. Therefore, the lamp is arranged in a sealed space, constructed by the reflector having an through hole part and a transparent glass plate covering the through hole part, to prevent the broken pieces of the lamp scattering out from the sealed space to the outside caused by a burst of the luminous tube. However, in the sealed space, heat generated the lamp makes the temperature inside the sealed space high. As a result, the life of the lamp is shortened due to longtime positioning the lamp in the excessively heated state.

In order to prolong the life of the lamp, at least one permeable port are defined on the reflector of the lamp for allowing air exchange between inside and outside of the lamp, through which the heat inside the lamp can be decreased effectively and the life of the lamp can be extended accordingly. However, the light emitted from the luminous tube of the lamp is prone to leak from the permeable port, which induces the lower efficiency of the usage of the light. In addition, the broken pieces of the lamp caused by the burst of the luminous tube are probable to get out from the permeable port of the reflector to threaten the user.

Therefore, it is desired to provide a light source system with high efficiency and being safe to use with.

### BRIEF DESCRIPTION OF THE DRAWINGS

FIG. 1 is a schematic, cross-sectional view of a light source system according to a first exemplary embodiment.

FIG. 2 is a schematic cross-sectional view of a light source system according to a second exemplary embodiment.

FIG. 3 is a schematic view of a projector using the light source system of FIG. 1 or 2.

### DETAILED DESCRIPTION OF THE PREFERRED EMBODIMENTS

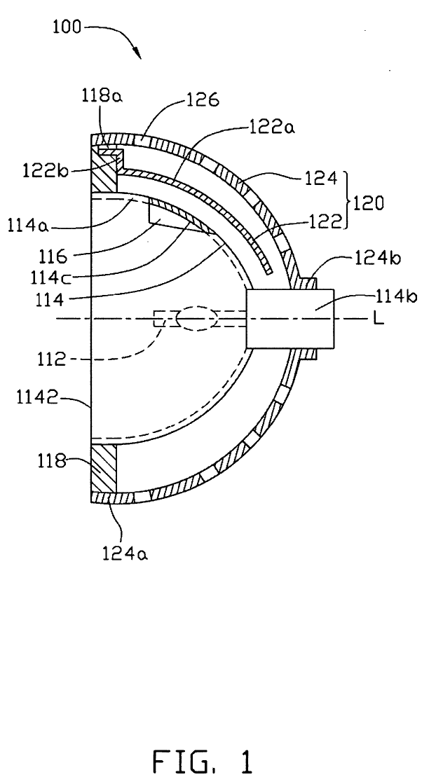

Referring to FIG. 1, a light source system 100 according to a first exemplary embodiment includes a lamp 112, a reflective device (also called as lampshade) 114, and a protecting device 120. The lamp 112 is received in the reflective device 114. The reflective device 114 has at least one through hole 116 defined thereon. The protecting device 120 is arranged on the outside of the reflective device 114 for preventing the light emitted from the lamp 112 leaking and the broken pieces of a burst lamp 112 escaped from the through hole 116 from getting out of the system.

The lamp 112 is composed of a high pressure mercury lamp having a luminous tube made of vitreous silica, and housed in the reflective device 114. Inside the luminous tube (not labeled), a pair of electrodes (not shown) are provided along an imaginary central axial line (lamp optical axis) L of a reflecting part of the reflective device 114. When discharge is performed between the pair of electrodes, a luminous part is formed between these electrodes, and light is emitting from the lamp 112. Alternatively, a metal halide lamp, a xenon lamp, or another lamp may be used as the lamp 112. The light emitted from the lamp 112 is reflected by the reflective device 114, then exits through a light outlet 1142 of the reflective device 114.

The reflective device 114 is a concave, semi-oval shell with the light outlet 1142 defined by an opening thereof. The reflective device 114 includes a front end 114a, a back end 114b and a middle wall 114c connecting with the front end 114a and the back end 114b. The lamp 112 is received in the reflective device 114 and fixed to the back end 114b. The through hole 116 is defined on the middle wall 114c of the reflective device 114 for allowing air exchanging between inside and outside of the reflective device 114 to cool the lamp 112. A flange 118 which is shaped like a circular ring is formed around the front end 114a of the reflective device 114 and configured for supporting the protecting device 120. The flange 118 is protruded out from the outer surface of the reflective device 114 by a predetermined distance for separating the protecting device 120 mounted thereon from the middle wall 114c by a predetermined distance. A notch 118a is defined on the end of the flange 118 and configured for receiving a portion of the protecting device 120.

The protecting device 120 is mounted on the outside of the reflective device 114 which includes a first portion, namely, light-shading element 122 and a second portion, namely, protecting element 124 respectively mounted on the outside of the reflective device 114.

The light-shading element 122 includes a shading portion 122a and a supporting portion 122b. The shading portion 122a is rightly aligned with the through hole 116 of the reflective device 114 and spaced away therefrom. The supporting portion 122b is connected to an edge of the shading portion 122a and matching the notch 118a of the flange 118 of the reflective device 114 for fixing the light-shading element 122 on the reflective device 114. The shading portion 122a is configured for reflecting the leaked light and stopping a portion of broken pieces of burst lamp 112 escaped from the through hole 116, and meanwhile allowing air exchanging between inside and outside of the reflective device 114. The shading portion 122a can be extended properly around the through hole 116 of the middle wall 114c in longitudinal and latitudinal directions to reflect and stop the leaked light and escaped broken pieces of the lamp 112 respectively. Alternatively, the area of the shading portion 122a can be larger than that of the through hole 116 for more effectively reflecting and stopping the leaked light and escaped broken pieces of the lamp 112 respectively. In addition, to improve the light reflectivity, the shading portion 122a is coated with a layer of the reflective material on a side thereof facing the through hole 116 of the reflective device 114. The light-shading element 112 can be made from reflective material such as metal or mica and so on.

The protecting element 124 is hollow shell shaped according the profile of the reflective device 114 and defines a number of ventilation holes 126 thereon. The protecting element 124 includes a first end 124a attached on the flange 118 of the reflective device 114, and a second end 124b attached on the back end 114b of the reflective device 114 such that the protecting element 124 is fixed on the reflective device and positioned outside the shading element 122. Understandably, the first end 124a and the second end 124b can be respectively attached on the corresponding flange 118 and the back end 114b by any suitable mechanical or chemic technology, such as bolt joint, adhesive joint and so on. Alternatively, if the protecting element 124 is of reticulation such a mesh having a number of holes that allow the air and light passing there through, the protecting element 124 and the light shading element 122 could be interchanged in the positions thereof, i.e., the protecting element 124 is positioned under the light-shading 122.

In the first exemplary embodiment of the light source system 100, the shading element 122 is employed to improve the efficiency of the usage of the light and the safety. The protecting element 124 is employed to prevent most of the broken pieces from escaping out from the light source system 100 for improving the safety of the light source system 100, while exchanging air from the reflective device 114 can flow through the ventilation holes 1142 of the protecting element 124 to cool lamp 112. Accordingly, the life of the light source 100 can be extended, accompanying with improvement of safety and light using efficiency.

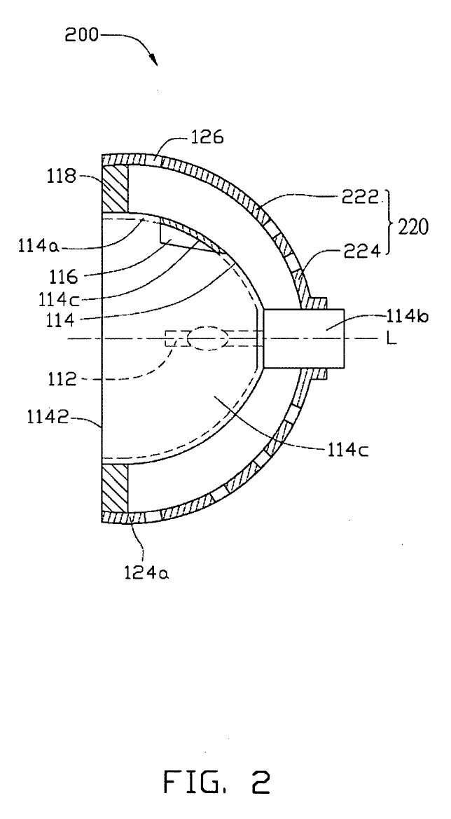

FIG. 2, is a light source 200 according to a second exemplary embodiment of the invention. The difference between the light source 100 according to the first embodiment and the light source 200 according to the instant embodiment is that the protecting device 220 having shading area 222 and a protecting area 224 connected and integrated with the shading area 222. The protecting device 220 is shaped according the profile of the reflective device 114 and mounted on the reflective device 114 in the manner of the shading area 222 of the protecting device 220 being substantially aligned with the through hole 116 of the reflective device 114 for shading and reflecting the leaked light and stopping the broken piece of the burst lamp 112. In addition, the shading area 222 is spaced from the reflective device 114 by a predetermined distance for exchanging air passing there through. The shading are 222 can be coated with a layer of the reflective material on a side facing the through hole 116 of the reflective device 114 to improve the reflectivity thereof. The protecting area 224, including a number of ventilation holes, is connected with the shading area 222 to form an integrated structure which can simplify the structure and manufacturing processes of the protecting device and also make the light source 200 compact and cheap.

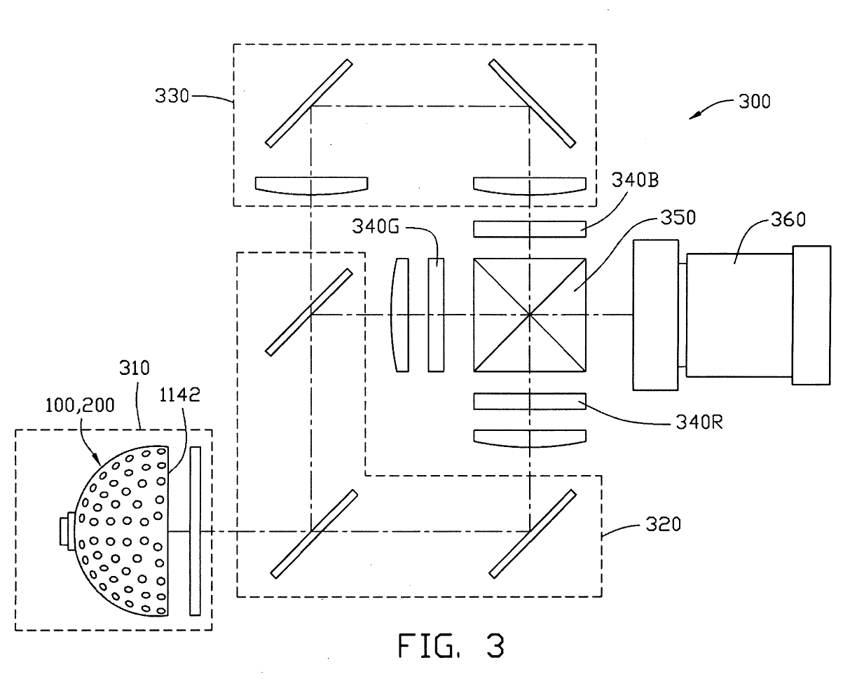

FIG. 3 is a plan view of a projector 300. The projector 300 includes an light source system 310, a color separation optical system 320, a relay optical system 330, three electro-optic modulating elements 340R, 340Q 340B, a cross dichroic prism 350, and a projecting lens 360. The components of each optical system are arranged nearly in the horizontal and vertical directions, centering around the cross dichroic prism 350. The light sources system 100 or 200 according to the first and second exemplary embodiments described above can be employed as the light source system 310 of the projector 300.

Under the above constitution, the light emitted from the light source system 310 is separated into light of each color of red R, green G, and blue B, and these color lights are respectively guided to three electro-optic modulating elements 340R, 340G, 340B, to be modulated according to image signals. Thereafter, each color light is compounded by the cross dichroic prism 350, enlarged by the projecting lens 360, and displayed on a screen.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light source system comprising:
a light source;
a reflective device receiving the light source therein and comprising a light outlet, the reflective device being configured for reflecting light emitted from the light source to the light outlet, the reflective device defining a through hole therein;
a protecting device mounted on the outside of the reflective device with a space left between the protecting device and the outer surface of the reflective device, the protecting device comprising a first portion substantially aligned with the through hole of the reflective device and a second portion, the first portion being configured for preventing light from leaking and objects from escaping out of the system, the second portion defining at least one ventilation hole thereon.

2. The light source system as claimed in claim 1, wherein the reflective device includes a front end, a back end and middle wall connecting with the front and back ends, the through hole defined on the middle wall.

3. The light source system as claimed in the claim 2, wherein a flange is formed on the front end of the reflective device and configured for supporting the protecting device thereon.

4. The light source system as claimed in the claim 3, wherein the first portion is a light-shading element and the second portion is a protecting element; the light-shading element is mounted on the flange; the protecting element includes a first end attached on the flange of the reflective device, and a second end attached on the back end to make the protecting element positioned over the light-shading element.

5. The light source system as claimed in the claim 4, wherein the flange defined a notch therein and a portion of the light-shading element is fixed in the notch of the flange.

6. The light source system as claimed in the claim 5, wherein the shading element includes a shading portion aligned with the through hole of the reflective device and a supporting portion connected on an edge of shading portion and fixed in the notch of the flange.

7. The light source system as claimed in the claim 6, wherein the shading portion of the shading element is extended around the through hole of the middle wall in longitudinal and latitudinal directions.

8. The light source system as claimed in the claim 7, wherein the area of the shading portion of the shading element is larger than that of the through hole of the reflective device.

9. The light source system as claimed in the claim 6, wherein the shading portion of the shading element is coated with a layer of a reflective material on a side thereof facing the through hole of the reflective device.

10. The light source system as claimed in the claim 1, wherein the first portion of the protecting device is a shading area and the second portion of the protecting device is a protecting area connected to the shading area and integrated with it.

11. The light source system as claimed in the claim 10, wherein the shading area is substantially aligned with the through hole of the reflective device.

12. The light source system as claimed in the claim 11, wherein the area of the shading area is larger than that of the through hole of the reflective device.

13. The light source system as claimed in the claim 10, wherein the shading area is coated with a layer of a reflective material on a side facing the through hole of the reflective device.

14. The light source system as claimed in the claim 1, wherein the protecting element is reticulated, and is positioned under the light shading element.

15. The light source system as claimed in the claim 1, wherein the protecting element is a mesh, and is positioned under the light shading element.

16. A light source system comprising:
a reflective device defining an through hole therein;
a lamp received in the reflective device; and
a protecting device arranged on the outside of the reflective device for prevent light emitted from the lamp from leaking and broken pieces of the bursting lamp from escaping out of the system.

17. The light source system as claimed in claim 16, wherein the protecting device includes light-shading element that is mounted on the outer side of the reflective device corresponding to the through hole of the reflective device and kept away from the through hole by a distance, and a protecting element mounted on the reflective device for cover the reflective device, the protecting element having a number ventilation holes.

18. The light source system as claimed in claim 17, wherein the reflective device includes a front end, a back end and middle wall connected the front and back ends, the through hole defined in the middle wall, a flange is formed on the front end of the reflective device; the shading element includes a shading portion aligned with through hole of the reflective device and a supporting portion which is connected on an edge of the supporting portion and positioned in the notch of the flange.

19. The light source system as claimed in the claim 16, wherein the protecting device includes a shading area and a protecting area integrated with the shading area, the shading area is substantially aligned with the through hole of the reflective device.

20. A projector comprising:
a light source system, the light source system comprising:
a light source;
a reflective device receiving the light source therein and comprising a light outlet, the reflective device being configured for reflecting light emitted from the light source to the light outlet, the reflective device defining a through hole therein;
a protecting device mounted on the outside of the reflective device with a space left between the protecting device and the outer surface of the reflective device, the protecting device comprising a first portion substantially aligned with the through hole of the reflective device and a second portion, the first portion being configured for prevent light from leaking and objects from escaping out of the system, the second portion defining at least one ventilation hole therein.
